(19) United States
(12) Patent Application Publication
(10) Pub. No.: US 2016/0136929 A1
(43) Pub. Date: May 19, 2016

(54) Composite Element and Use Thereof

(71) Applicant: SCHOTT AG, Mainz (DE)

(72) Inventors: Jens MEISS, Rodgau (DE); Clemens OTTERMANN, Hattersheim (DE); Hauke ESEMANN, Wörrstadt (DE); Joerg Hinrich FECHNER, Köln (DE); Andreas ORTNER, Gau-Algesheim (DE); Rainer LIEBALD, Nauheim (DE); Klaus-Peter KUREK, Mainz (DE); Markus HEISS-CHOUQUET, Bischofsheim (DE)

(73) Assignee: SCHOTT AG, Mainz (DE)

(21) Appl. No.: 15/006,196

(22) Filed: Jan. 26, 2016

Related U.S. Application Data
(63) Continuation of application No. PCT/EP2014/064887, filed on Jul. 11, 2014.

(30) Foreign Application Priority Data
Jul. 24, 2013 (DE) 102013214422.9

(51) Int. Cl. B32B 17/10; B29C 65/00; B32B 37/16; B32B 38/10; B32B 7/12; B32B 37/10

(52) U.S. Cl. CPC B32B 17/1077; B32B 7/12; B32B 17/10779; B32B 17/10036; B32B 17/10137; B32B 17/10798; B32B 17/10816; B32B 37/1018; B32B 37/10; B32B 37/16; B32B 38/10; B29C 66/45; B29C 66/7465; B29C 66/0224; B32B 2255/26; B32B 2307/412; B32B 2307/54; B32B 2307/542; B32B 2307/536; B32B 2307/3065; B32B 2419/00; B32B 2605/18; B32B 2309/02; B32B 2315/08; B29L 2031/778

(57) ABSTRACT

A lightweight composite panel is provided that includes at least one mineral glass or glass-ceramic panel and at least one organic layer. The weight per unit area of the lightweight composite panel is in the range from 0.5 kg/m² to 5.5 kg/m², the ratio of the total thickness of the one or more mineral glass or glass-ceramic panels to the total thickness of all of the organic layers is from 1:0.01 to 1:1 and the total thickness of all of the organic layers is less than or equal to 350 μm. The lightweight composite panel complies with the thermal safety requirements of the air travel authorities and its “Total Heat Release,” measured in accordance with JAR/FAR/CS 25, App. F, Part IV & AITM 2.0006, is less than 65 kW×min/m² and its flame time after removal of the flame in the “Vertical Bunsen Burner Test”, measured in accordance with FAR/JAR/CS 25, App. F, Part 1 & AITM 2.0002A, is less than 15 s.

### CROSS REFERENCE TO RELATED APPLICATIONS

This application is a continuation of International Application No. PCT/EP2014/064887 filed Jul. 11, 2014, which claims benefit under 35 U.S.C. §119(a) of German Patent Application No. 10 2013 214 422.9 filed Jul. 24, 2013, the entire contents of both of which are incorporated herein by reference.

### BACKGROUND

1. Field of the Invention

The present invention relates to a composite element having at least one mineral glass or glass-ceramic layer and at least one organic layer that is adjacent to the glass or glass-ceramic layer and having a low total weight per unit area and a low heat release rate as well as to a method for the manufacture and use of such a composite element. The invention further comprises an interior aircraft window pane or lightweight window pane and a smoke barrier element with such a composite element.

2. Description of Related Art

Glass/plastic composite panels for use in vehicles on land, on water, and in the air as well as for use in the field of architecture and in the field of interior furnishings have been described in diverse ways in the prior art and meet many requirements that are posed. However, some applications, above all those in the field of transportation, such as in aircraft manufacture and electric vehicle manufacture, pose requirement profiles for which until now no solutions have been demonstrated in the prior art. To be mentioned here are, above all, panels that have a low weight per unit area and, at the same time, meet high thermal safety requirements, coupled with a high optical transparency, a good scratch resistance, and a good chemical resistance.

For special applications, such as, for example, those in aviation, special safety requirements need to be met and necessitate an improvement in the known composite materials. In the cabin area—for example, as panels for interior furnishing elements such as partitions or as panels for windows and doors—high thermal safety requirements are posed, such as those described in detail in the “C.F.R. (Code of Federal Regulations, Title 14, Aeronautics and Space, Chapter I Federal Aviation Administration, Department of Transportation, Part 25 Airworthiness Standards, Transport Categories Airplanes, Appendix F,” or in “Environmental Conditions and Test Procedures for Airborne Equipment of RTCA (Radio Technical Commission for Aeronautics)/DO-160G”, or in the “Material Qualification Requirements Glass Materials” of Lufthansa Technik or in the corresponding regulations of the EASA (European Aviation Safety Agency), such as CS-25 (“Certification Specifications for Large Aeroplanes”). The heat release and properties such as heat resistance, flammability, burn length, flame time, drip flame time, smoke gas density, and toxicity limits with respect to smoke gases are key values for evaluating thermal safety and fire protection requirements. There are stringent provisions and narrow limits for each of these.

For the “Heat Release Rate Test for Cabin Materials” in compliance with the FAR Standard (Federal Aviation Regulation) 25.853c/d App. F Part IV, the test piece is exposed to the action of heat and surface flame treatment in a chamber during the test in a defined manner. A peak heat release rate of less than 65 kW/m² and a total heat release of less than 65 kW*min/m² within 2 minutes is required. Further requirements in regard to flammability, such as those described in FAR 25.853a App. F Part I (a)(1)(i) and determined by means of a “vertical Bunsen burner test,” require a burn length of less than 152 mm, a flame time of less than 15 s, and a drip flame time, that is, the flame time of material dripping during the fire, of less than 3 s. In this test, the test piece is exposed to a defined flame (length 38 mm, Bunsen burner with an inner diameter of 10 mm) directly at the edge at a distance of 19 mm for the duration of one minute.

In addition to this, limits with respect to the weight per unit area of such interior furnishing elements have to be observed on account of requirements from the air travel industry, for example. Glass panes or panels in known form are excluded on account of their weight per unit area for adequate strength or, when the required weight per unit area is observed, they are excluded on account of a strength that is too low or on account of their tendency to scatter shards in the event that they break, even when they meet the thermal safety requirements. Although panels made of a polymer material do meet the requirements placed on the weight per unit area, they do not meet the applicable fire protection requirements. However, an improvement in flame protection for such polymer panels always entails losses in terms of the transparency of such materials, as a result of which they then cannot be used for applications as viewing windows, for example. Although known panels made of a glass/polymer laminate composite do meet the requirements placed on transparency and thermal safety, they do not meet those placed on weight per unit area, such as, for example, composite glass panels as are known, for example, as windshields for motor vehicles or as composite safety glass in the field of architecture. Other glass/polymer laminate composite panels, such as those described below in the listing of the prior art, do not meet the applicable fire protection requirements.

Because panels according to the prior art do not meet the applicable specifications in aircraft manufacture, special permits of the respectively competent air travel authorities apply there. Thus, at present, it is standard practice to use panels made of polycarbonate (PC) or polymethyl methacrylate (PMMA) as window elements or door elements or components of a window or of a door or as partitions. They are manufactured, for example, as extruded plates, from which the corresponding contour is then cut out, or else they are manufactured by injection molding methods, in which the contour is directly formed. For improvement of the fire protection safety, the materials can be furnished with additives. In spite of this, however, such panels do not comply in any case with all of the requirements of international provisions in regard to fire safety protection, such as, for example, those that have been established by the FAA (Federal Aviation Administration) of the United States and imposed internationally, such as, for example, the JAR (“Joint Aviation Requirements”) or the CS (“Certification Specifications”) of the EASA. Moreover, such panels do not have a scratch resistance that is comparable to that of glass, despite in part additional coatings with hard materials, such as those known in the prior art. Solely their low weight per unit area is advantageous. The thickness of such a PC or PMMA panel, employed in standard practice as window panes of interior furnishings in aircraft is typically about 2 mm with a weight per unit area of 2.4 kg/m² and is regarded as a reference standard for corresponding further developments or alternatives.

According to the prior art, DE 44 15 878 A1 discloses a composite glass panel that is intended for use in motor vehicles. This composite glass panel is three-layered with two glass layers, between which the plastic plate is arranged. The plastic core, which has a thickness of between 1 and 4 mm, supports the two glass layers, so that, in spite of their lesser thickness of between 0.2 and 1.5 mm, the composite glass panel has a certain strength. The glass layers are bonded to the plastic core via an elastic two-component silicone rubber with a thickness of between 0.01 and 0.5 mm, which was formed between the plastic plate and each glass layer as a stress-compensating adhesive layer. In this way, it was already possible to reduce appreciably the weight of a composite glass panel. In order to counteract external effects, such as, for example, the danger due to impact of a stone, however, it is necessary in this case to observe a minimum thickness of the glass layers and, as a result of this, the weight savings are limited. The total thickness of the proposed composite panel is theoretically 1.42 to 8.0 mm in this case. On account of the relatively thick organic layer, this composite panel does not afford any adequate fire protection safety, such as that necessitated, for example, in the requirements for air travel.

Likewise, DE 102009021938 A1, in an enhancement of DE 44 15 878 A1, shows a composite glass panel, in particular for use as a motor vehicle panel or as facade cladding, composed of a plastic plate made of transparent plastic with a thickness of between 1 mm and 10 mm and composed of at least one glass layer, which is tightly bonded to the plastic plate. For further weight savings, the intermediate layer was dispensed with and the glass layer is designed to be thinner with a thickness of between 0.02 mm and 0.1 mm. Here, too, a relatively thick plastic plate is proposed, which is likewise appreciably thicker than the glass layer, so that this composite panel does not meet the thermal safety requirements, such as those demanded in the requirements for air travel, for example.

Corresponding proposals are made also by EP 0 669 205, DE 10 2010 037, and WO 2011/152380, for example. A drawback is always that the plastic layer is too thick in relation to the glass thickness. Such panels do not meet the thermal safety requirements of air travel, at least not the requirements with respect to the “heat release rate,” because the heat release is always too high, thereby supporting fire, nor do they meet the requirements according to the “vertical burner test,” because the proportion of organics in the composite panels is too high.

DE 20 2010 013 869 U1 shows interior furnishing elements for vehicle cabins, in particular those of aircraft. To be provided, in particular, is an improved interior furnishing element for vehicle cabins, which can have at least a first portion, which can have a transparent plastic support substrate, on the surface of which a glass coating is applied. Such a glass coating is intended to afford an especially scratch-resistant surface as well as advantages in terms of heat resistance and flame retardancy. The glass-coated first portion can comprise a second portion—for example, a frame—which is preferably manufactured from a composite material and which is bonded to the first portion in a cohesive, form-fitting, and/or force-fitting manner. In this case, the first and second portions can be tightly bonded to each other. Although the term “light structural element” is given in general form, the thickness of the glass coating is relatively small here, too, in comparison to the thickness of the plastic support material. The thickness of the glass coating is chosen in such a way that it is adequately stable in mechanical terms and, if need be, further requirements can be met. All in all, however, no dimensions are stated in this prior art. Because the thickness of the plastic support material is relatively greater in comparison to the thickness of the glass coating, this composite panel likewise does not meet the fire protection requirements, such as those stipulated in the requirements for air travel, for example.

### SUMMARY

The object of the invention is accordingly to provide a composite element that, besides an adequately small weight per unit area, also adequately satisfies the thermal safety requirements of the current provisions ensuing from the requirements for air travel. In doing so, a reference value of 2.4 kg/m² applies as weight per unit area and reference to the FAA regulations corresponding to the “Aircraft Materials Fire Test Handbook,” in particular to the “total heat release rate,” applies as thermal safety requirements.

The lightweight composite panel of the invention meets the demands placed on thermal safety requirements. The lightweight composite panel meets the requirements with respect to total heat release as the most critical parameter, that is, the absolute heat release or the release of the absolute amount of heat, in compliance with the stipulations and test conditions of the FAA corresponding to the “Aircraft Materials Fire Test Handbook,” DOT/FAA/AR-00/12, Chapter 5 “Heat Release Rate Test for Cabin Materials,” and has a total heat release, measured in compliance with JAR/FAR/CS 25, App. (Appendix) F, Part IV & AITM (Airbus Industries Test Method) 2.0006, of less than 65 kW×min/m², preferably of less than 50 kW×min/m², more preferably of less than 40 kW×min/m², particularly preferred of less than 20 kW×min/m².

As a further parameter with respect to the thermal safety requirements, the lightweight composite panel meets the requirements with respect to the “vertical Bunsen burner test,” that is, the vertical Bunsen burner test with a flame directed vertically on the bottom edge of the test material, in compliance with the stipulations and test conditions of the FAA according to the “Aircraft Materials Fire Test Handbook,” DOT/FAA/AR-00/12, Chapter 1 “Vertical Bunsen Burner Test for Cabin and Cargo Compartment Materials,” and has a flame time after removal of the flame in the test, measured in compliance with FAR/JAR/CS 25, App. F, Part I, of less than 15 s, preferably less than 8 s, more preferably less than 3 s, particularly preferred less than 1 s. Such short flame times are attained on account of a self-extinguishing behavior that is achieved by way of the structure of the lightweight composite panel of the invention. In especially preferred embodiments, flame times of down to 0 seconds are attained.

In complying with these requirements, the lightweight composite panel of the invention comprises at least one mineral glass or glass-ceramic panel and at least one organic layer A and has a weight per unit area with a lower limit of greater than or equal to 0.5 kg/m², preferably of greater than or equal to 1 kg/m², more preferably of greater than or equal to 1.3 kg/m², in particular of greater than or equal to 1.5 kg/m², in particular of greater than or equal to 1.8 kg/m², in particular of greater than or equal to 2 kg/m², and has a weight per unit area with an upper limit of less than or equal to 5.5 kg/m², preferably of less than or equal to 3 kg/m², more preferably of less than or equal to 2.5 kg/m², in particular of less than or equal to 2.3 kg/m². In further advantageous embodiments, the weight per unit area of the lightweight composite panel has a lower limit of greater than or equal to 0.6 kg/m², in particular of greater than or equal to 0.8 kg/m², greater than or equal to 0.9 kg/m², 1.1 kg/m², 1.2 kg/m², 1.4 kg/m², 1.6 kg/m², 1.7 kg/m², 1.9 kg/m², and 2.1 kg/m². In further advantageous embodiments, the weight per unit area of the lightweight composite panel has an upper limit of less than or equal to 5.5 kg/m², in particular of less than or equal to 5.0 kg/m², 4.5 kg/m², 4.0 kg/m², 3.5 kg/m², 2.8 kg/m², 2.6 kg/m², 2.4 kg/m², and 2.2 kg/m².

In an inventive way, in order to meet the thermal safety requirements, in addition to the weight per unit area, the ratio of the total thickness of the least one, that is, of one or more mineral glass or glass-ceramic panels to the total thickness of all of the organic layers in this case is 1:0.01 to 1:1, in particular 1:0.01 to 1:0.9, preferably 1:0.01 to 1:0.6, more preferably 1:0.01 to 1:0.3, in particular 1:0.01 to 1:0.25, particularly preferred 1:0.01 to 1:0.2, most preferably 1:0.01 to 1:0.15, in particular 1:0.01 to 1:0.1, and the total thickness of all of the organic layers is less than or equal to 450 μm, in particular less than or equal to 350 μm, in particular less than or equal to 300 μm, in particular less than or equal to 240 μm, preferably less than or equal to 200 μm, in particular less than or equal to 150 μm, more preferably less than or equal to 100 μm, in particular less than or equal to 80 μm, most preferably less than or equal to 70 μm, in particular less than or equal to 50 μm, and in particular less than or equal to 30 μm, and in particular less than or equal to 25 μm.

In order to observe the thermal safety requirements, in particular in regard to the total heat release and the flame time in the “vertical Bunsen burner test” or the “Bunsen burner test,” on the one hand, the absolute amount of heat released by the proportion of organics in the lightweight composite panel, which are combustible, is crucial, for which reason the total thickness of the organic layers is limited in an inventive way for the given weights per unit area. However, on the other hand, not only the absolute amount of heat-releasing or combustible organics is crucial, but, within the given weights per unit area, the ratio between the noncombustible mineral glass or glass ceramic and the total proportion of organics in such a lightweight composite panel is also of crucial importance in order to meet the thermal safety requirements. How much of the heat capacity is supplied on the part of the glass or glass ceramic in a lightweight composite panel and thus how much heat can be absorbed by the glass or glass ceramic within the limit of the weight per unit area for the lightweight composite panel play a role here.

In order to also be able to employ such lightweight composite panels economically for various applications, above all in the areas of transportation and architecture, but also to place a limit on the absolute proportion of organics in regard to the fire protection requirements, the inventive lightweight composite panel is also characterized by the given weights per unit area, with observation of the given ratio limits between noncombustible glass or glass ceramic and the proportion of organics.

For many applications, the optical properties, in particular the transparency of the lightweight composite panel, are a key feature. Included here are window or door elements or components of a window or of a door, partitions, or else smoke gas barrier elements, so-called smoke barriers, in the field of architecture or as furnishing elements for vehicle cabins in the field of transportation—for example, interior window panes in an aircraft or glazing in an electric vehicle. Especially where the weight per unit area assumes a decisive role, attempts to adapt light materials to the thermal safety requirements have so far failed owing to the quality of the optical properties. Any marked improvement in the thermal properties of polymeric materials in the direction of flame retardancy or in terms of flammability has always occurred at the expense of transparency in an unacceptable manner.

Transparency is understood to be the property of a layer, of a panel, or of a composite panel with a transmittance of greater than or equal to 80 percent in the visible wavelength range of light of 380 nm to 900 nm, in particular of 420 nm to 800 nm.

The inventors have succeeded in providing a lightweight composite panel that is compatible with the requirements placed on the optical properties for a viewing window for the various fields of application, while observing the above-mentioned thermal safety requirements and the given low weight per unit area. Thus, the transparency of the lightweight composite panel in each of the preferred embodiments is greater than 80%, preferably greater than 85%, more preferably greater than 88%, particularly preferred greater than 90%. The transparency of the lightweight composite panel can even be greater than 91% in these cases. In an inventive way, the glass or glass-ceramic layer has a corresponding transparency and the transparency of the organic layers is in part even higher in this case, also on account of its limited layer thickness. Thus, in the especially preferred embodiment as transparent adhesive film in the design of an optically clear adhesive (OCA), the organic layer has an internal transmittance of greater than 99%. Internal transmittance is understood to mean the internal light transport through the layer material without taking into account reflection losses.

In addition, in the preferred embodiment of the lightweight composite panel with good optical properties, however, an outstanding absence of streaks, low haze or low scattering behavior, no distortions, and a neutral rendition of colors (corresponding to the color rendering index DIN EN 410) are afforded. Here, too, the ratio of the total thickness of the one or more mineral glass or glass-ceramic panels to the total thickness of all of the organic layers is of advantage. Thus, the optical scattering behavior (haze) of the lightweight composite panel is less than or equal to 1.5%, preferably less than or equal to 1.0%, more preferably less than or equal to 0.5%, measured with a HazeGard, measurement according to ASTM D1003 D1044. The color rendering index of the lightweight composite panel according to DIN* EN 410 is greater than or equal to 95, preferably greater than or equal to 98, more preferably greater than or equal to 99.

The base support plate of the lightweight composite panel of the invention is a mineral glass panel or a glass ceramic, with the thickness of the at least one glass or glass-ceramic panel being less than or equal to 1 mm, preferably less than or equal to 0.8 mm, more preferably less than or equal to 0.6 mm, and greater than or equal to 200 μm, preferably greater than or equal to 350 μm, more preferably greater than or equal to 450 μm, particularly preferred greater than or equal to 500 μm, in particular greater than or equal to 530 μm. Advantageous thicknesses are 0.2 mm, 0.21 mm, 0.3 mm, 0.4 mm, 0.55 mm, 0.7 mm, 0.9 or 1.0 mm.

Preferably used in this case is a glass or a glass ceramic that is prestressed for its use. This glass or this glass ceramic can be prestressed chemically by ion exchange or thermally or by a combination of thermal and chemical methods.

The at least one mineral glass panel, that is, the one glass panel or a second glass panel or else at least one additional glass panel, is composed preferably of a lithium aluminum silicate glass, a soda-lime silicate glass, a borosilicate glass, an alkali aluminosilicate glass, or an alkali-free or low-alkali aluminosilicate glass. Such glasses are obtained, for example, by means of drawing methods, such as a down-draw method, by means of overflow fusion, or by means of float technology.

Advantageously, a low-iron or iron-free glass, in particular one with an Fe₂O₃ content of less than 0.05 wt %, preferably less than 0.03 wt %, can be used, because it exhibits reduced absorption and thus makes possible, in particular, an increased transparency.

For other applications, however, gray glasses or colored glasses are also preferred. An optical glass can also serve as base support material, such as, for example, a heavy flint glass, a lanthanum heavy flint glass, a flint glass, a light flint glass, a crown glass, a borosilicate crown glass, a barium crown glass, a heavy crown glass, or a fluorine crown glass.

Preferably used as support material are lithium aluminum silicate glasses of the following glass compositions, composed of (in wt %):

| | |
|---|---|
| SiO₂ | 55-69 |
| Al₂O₃ | 19-25 |
| Li₂O | 3-5 |
| Total Na₂O + K₂O | 0-3 |
| Total MgO + CaO + SrO + BaO | 0-5 |
| ZnO | 0-4 |
| TiO₂ | 0-5 |
| ZrO₂ | 0-3 |
| Total TiO₂ + ZrO₂ + SnO₂ | 2-6 |
| P₂O₅ | 0-8 |
| F | 0-1 |
| B₂O₃ | 0-2, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-1 wt %, as well as refining agents, such as As₂O₃, Sb₂O₃, SnO₂, SO₃, Cl, F, CeO₂ of 0-2 wt %.

Further preferably used as support material are soda-lime silicate glasses of the following glass compositions, composed of (in wt %):

| | |
|---|---|
| SiO₂ | 40-80 |
| Al₂O₃ | 0-6 |
| B₂O₃ | 0-5 |
| Total Li₂O + Na₂O + K₂O | 5-30 |
| Total MgO + CaO + SrO + BaO + ZnO | 5-30 |
| Total TiO₂ + ZrO₂ | 0-7 |
| P₂O₅ | 0-2, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-5 wt % or, for “black glass,” of 0-15 wt %, as well as refining agents, such as As₂O₃, Sb₂O₃, SnO₂, SO₃, Cl, F, CeO₂ of 0-2 wt %.

Further preferably used as support material are borosilicate glasses of the following glass compositions, composed of (in wt %):

| | |
|---|---|
| SiO₂ | 60-85 |
| Al₂O₃ | 1-10 |
| B₂O₃ | 5-20 |
| Total Li₂O + Na₂O + K₂O | 2-16 |
| Total MgO + CaO + SrO + BaO + ZnO | 0-15 |
| Total TiO₂ + ZrO₂ | 0-5 |
| P₂O₅ | 0-2, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-5 wt % or, for “black glass,” of 0-15 wt %, as well as refining agents, such as As₂O₃, Sb₂O₃, SnO₂, SO₃, Cl, F, CeO₂ of 0-2 wt %.

Further preferably used as support material are alkali aluminosilicate glasses of the following glass compositions, composed of (in wt %):

| | |
|---|---|
| SiO₂ | 40-75 |
| Al₂O₃ | 10-30 |
| B₂O₃ | 0-20 |
| Total Li₂O + Na₂O + K₂O | 4-30 |
| Total MgO + CaO + SrO + BaO + ZnO | 0-15 |
| Total TiO₂ + ZrO₂ | 0-15 |
| P₂O₅ | 0-10, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-5 wt % or, for “black glass,” of 0-15 wt %, as well as refining agents, such as As₂O₃, Sb₂O₃, SnO₂, SO₃, Cl, F, CeO₂ of 0-2 wt %.

Further preferably used as support material are alkali-free aluminosilicate glasses of the following glass compositions, composed of (in wt %):

| | |
|---|---|
| SiO₂ | 50-75 |
| Al₂O₃ | 7-25 |
| B₂O₃ | 0-20 |
| Total Li₂O + Na₂O + K₂O | 0-0.1 |
| Total MgO + CaO + SrO + BaO + ZnO | 5-25 |
| Total TiO₂ + ZrO₂ | 0-10 |
| P₂O₅ | 0-5, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-5 wt % or, for “black glass,” of 0-15 wt %, as well as refining agents, such as As₂O₃, Sb₂O₃, SnO₂, SO₃, Cl, F, CeO₂ of 0-2 wt %.

Further preferably used as support material are alkali-poor aluminosilicate glasses of the following glass compositions, composed of (in wt %):

| | |
|---|---|
| SiO₂ | 50-75 |
| Al₂O₃ | 7-25 |
| B₂O₃ | 0-20 |
| Total Li₂O + Na₂O + K₂O | 0-4 |
| Total MgO + CaO + SrO + BaO + ZnO | 5-25 |
| Total TiO₂ + ZrO₂ | 0-10 |
| P₂O₅ | 0-5, |

as well as, if need be, additions of coloring oxides, such as, for example, Nd₂O₃, Fe₂O₃, CoO, NiO, V₂O₅, Nd₂O₃, MnO₂, TiO₂, CuO, CeO₂, Cr₂O₃, rare earth oxides in contents of 0-5 wt % or, for “black glass,” of 0-15 wt %, as well as refining agents, such as As₂O₃, Sb₂O₃, SnO₂, SO₃, Cl, F, CeO₂ of 0-2 wt %.

Especially preferred are, for example, thin glasses, such as those marketed by Schott AG, Mainz under the trade names D263, D263 eco, B270, B270 eco, Borofloat, Xensation Cover, Xensation Cover 3D, AF45, AF37, AF32, or AF32 eco.

In another embodiment, the at least one mineral panel, that is, one panel or a second panel or else at least one further panel, is a glass ceramic, with the at least one glass-ceramic panel composed of a ceramicized aluminosilicate glass or lithium aluminosilicate glass, in particular one made of a chemically and/or thermally hardened ceramicized aluminosilicate glass or lithium aluminosilicate glass. In another embodiment, the panel or the panels is or are composed of a ceramicizable starting glass, which, in the event of a fire, is ceramicized or further progressively ceramicized under the effect of heat and, as a result, affords an increased fire protection safety.

Preferably used is a glass ceramic or a ceramicizable glass having the following composition of the starting glass (in wt %):

| | |
|---|---|
| Li₂O | 3.2-5.0 |
| Na₂O | 0-1.5 |
| K₂O | 0-1.5 |
| Total Na₂O + K₂O | 0.2-2.0 |
| MgO | 0.1-2.2 |
| CaO | 0-1.5 |
| SrO | 0-1.5 |
| BaO | 0-2.5 |
| ZnO | 0-1.5 |
| Al₂0₃ | 19-25 |
| SiO₂ | 55-69 |
| TiO₂ | 1.0-5.0 |
| ZrO₂ | 1.0-2.5 |
| SnO₂ | 0-1.0 |
| Total TiO₂ + ZrO₂ + SnO₂ | 2.5-5.0 |
| P₂O₅ | 0-3.0. |

In another embodiment, a glass ceramic or a ceramicizable glass having the following composition of the starting glass is preferably used (in wt %):

| | |
|---|---|
| Li₂O | 3-5 |
| Na₂O | 0-1.5 |
| K₂O | 0-1.5 |
| Total Na₂O + K₂O | 0.2-2 |
| MgO | 0.1-2.5 |
| CaO | 0-2 |
| SrO | 0-2 |
| BaO | 0-3 |
| ZnO | 0-1.5 |
| Al₂0₃ | 15-25 |
| SiO₂ | 50-75 |
| TiO₂ | 1-5 |
| ZrO₂ | 1-2.5 |
| SnO₂ | 0-1.0 |
| Total TiO₂ + ZrO₂ + SnO₂ | 2.5-5 |
| P₂O₅ | 0-3.0. |

In another embodiment, a glass ceramic or a ceramicizable glass having the following composition of the starting glass is preferably used (in wt %):

| | |
|---|---|
| Li₂O | 3-4.5 |
| Na₂O | 0-1.5 |
| K₂O | 0-1.5 |
| Total Na₂O + K₂O | 0.2-2 |
| MgO | 0-2 |
| CaO | 0-1.5 |
| SrO | 0-1.5 |
| BaO | 0-2.5 |
| ZnO | 0-2.5 |
| B₂0₃ | 0-1 |
| Al₂0₃ | 19-25 |
| SiO₂ | 55-69 |
| TiO₂ | 1.4-2.7 |
| ZrO₂ | 1.3-2.5 |
| SnO₂ | 0-0.4 |
| Total TiO₂ + SnO₂ | less than 2.7 |
| P₂O₅ | 0-3 |
| Total ZrO₂ + 0.87 (TiO₂ + SnO₂) | 3.6-4.3. |

For a transparency of the at least one glass-ceramic panel of >80%, the content of TiO₂ is more preferably less than 2 wt % of the content of SnO₂, more preferably less than 0.5 wt %, and the content of Fe₂O₃ is more preferably less than 200 ppm.

The glass ceramic preferably contains high-quartz mixed crystals or keatite mixed crystals as predominant crystal phase. The crystallite sizes are advantageously smaller than 70 nm, more preferably smaller than exactly 50 nm, most preferably smaller than exactly 10 nm.

In this preferred embodiment of the invention, in order to improve above all the fracture strength and the scratch resistance of the at least one mineral glass or glass-ceramic panel, it is prestressed chemically and/or thermally. In particular for the special application as an interior furnishing element in air travel, such as, for example, as an interior window pane, such a lightweight composite panel has to withstand an “abuse load test” or a “ball drop test,” such as the one given, for example, in the “Lufthansa Technik Material Qualification Requirements.” This needs to be observed for a lightweight composite panel of the invention when it has been prestressed thermally and/or chemically, while limiting the thickness of a glass or glass-ceramic panel.

Known are thermal and chemical prestressing processes. In thermal prestressing processes, the entire glass object is heated and then the glass surface is quenched by blowing cold air rapidly against it. As a result, the surface solidifies immediately, whereas the interior of the glass further contracts. This results in a tensile stress in the interior and a compressive stress correspondingly on the surface. Usually, however, thermal prestressing processes are less suitable for thin glasses with a thickness of less than 1 mm or 0.5 mm.

In an embodiment of the invention, the at least one mineral glass or glass-ceramic panel is advantageously prestressed thermally prior to a chemical prestressing.

The invention relates more preferably to an embodiment of the glass or glass-ceramic panel as a chemically prestressed substrate. The chemical prestressing can occur in one stage or else in multiple stages. In particular, alkali- or lithium-containing glasses or glass ceramics in which sodium ions are replaced by potassium ions or lithium ions by sodium ions are used. The replacement of smaller ions by larger ions in this way in the surface of the glass or glass-ceramic panel creates a compressive stress. The ion exchange occurs, for example, in a corresponding salt bath, such as KNO₃ or NaNO₃ or AgNO₃ or any desired mixture of these salts or in a multistage process using KNO₃ and/or NaNO₃ and/or AgNO₃. The prestressing temperatures in this case are in the range of 350° to 490° with a prestressing time of 1 to 16 hours. The ion exchange in an AgNO₃ salt bath occurs, in particular, by inclusion of silver ions in order to design the surface to be antibacterial.

In the embodiment of the invention with a one-stage prestressed glass or glass-ceramic panel, the compressive stress on the surface is at least 600 MPa, preferably at least 800 MPa, for a penetration depth of the exchanged ions of greater than or equal to 30 μm, in particular greater than or equal to 40 μm.

In the embodiment of the invention with a multistage prestressed glass or glass-ceramic panel, the compressive stress on the surface can be less, whereby, however, in the multistage prestressing, the penetration depth of the exchanged ions is increased, so that the strength of the prestressed glass or of the prestressed glass ceramic can be higher overall. In particular, the compressive stress on the surface of the glass or glass-ceramic panel can be at least 500 MPa for a penetration depth of greater than or equal to 50 μm, in particular greater than or equal to 80 μm. For multistage prestressing, the penetration depth can even be greater than 100 μm.

The ion-exchange depth of a chemical hardening for a glass or glass-ceramic panel in a lightweight composite panel is greater than or equal to 30 μm, preferably greater than or equal to 40 μm, more preferably greater than or equal to 50 μm, particularly preferred greater than or equal to 80 μm, and the surface compressive stress of a glass or glass-ceramic panel in a lightweight composite panel is greater than or equal to 500 MPa, preferably greater than or equal to 600 MPa, more preferably greater than or equal to 700 MPa, particularly preferred greater than or equal to 800 MPa, particularly preferred greater than 900 MPa.

The penetration depth of the exchanged ions and thus the surface zones of a higher compressive stress in the glass or glass-ceramic panel increase the strength of the glass or glass-ceramic panel. However, in each case, the penetration depth needs to be tuned to the total thickness of the glass or glass-ceramic panel, since, if the tensile stress that is created in the interior of the glass or glass-ceramic panel during chemical hardening is too high, the glass or glass-ceramic panel will break. When the glass or glass-ceramic panel is subjected to bending through the action of an external force, the panel responds more sensitively owing to its internal tensile stress. The interior tensile stress for the glass or glass-ceramic panel is therefore less than or equal to 50 MPa, preferably less than or equal to 30 MPa, more preferably less than or equal to 20 MPa, particularly preferred less than or equal to 15 MPa. The surface compressive stress of the glass or glass-ceramic panel is greater than or equal to 500 MPa, preferably greater than or equal to 600 MPa, more preferably greater than or equal to 700 MPa, particularly preferred greater than or equal to 800 MPa, in particular greater than or equal to 900 MPa.

The 4-point bending strength in compliance with DIN EN 843-1 or DIN EN 1288-3 of the at least one mineral glass or glass-ceramic panel or of a glass or glass-ceramic panel in a lightweight composite panel is greater than or equal to 550 MPa, preferably greater than or equal to 650 MPa, more preferably greater than or equal to 800 MPa.

The Young modulus or modulus of elasticity of the at least one mineral glass or glass-ceramic panel or of a glass or glass-ceramic panel in a lightweight composite panel is greater than or equal to 68 GPa, preferably greater than or equal to 73 GPa, more preferably greater than or equal to 74 GPa, particularly preferred greater than or equal to 80 GPa.

The shear modulus of the at least one mineral glass or glass-ceramic panel or of a glass or glass-ceramic panel in a lightweight composite panel is greater than or equal to 25 GPa, preferably greater than or equal to 29 GPa, more preferably greater than or equal to 30 GPa, particularly preferred greater than or equal to 33 GPa.

Above all, a prestressed glass or glass-ceramic panel has a high surface hardness and affords a high resistance against scratching and scoring due to the action of external force. In compliance with DIN EN 843-4 or EN ISO 6507-1, the Vickers hardness of a non-prestressed mineral glass or glass-ceramic panel or of the glass or glass-ceramic panel in a non-prestressed state is greater than or equal to 500 HV 2/20, preferably greater than or equal to 560 HV 2/20, more preferably greater than or equal to 610 HV 2/20, or the Vickers hardness of at least one mineral glass or glass-ceramic panel or in a prestressed state is greater than or equal to 550 HV 2/20, preferably greater than or equal to 600 HV 2/20, more preferably greater than or equal to 650 HV 2/20, particularly preferred greater than or equal to 680 HV 2/20 for a test force of 2 N (corresponding to a weight of 200 g).

The use of a glass or glass-ceramic panel as an outer layer for a lightweight composite panel has, besides the aspects of fire protection safety and scratch resistance, also the advantage of a good chemical resistance, in particular towards cleaning agents. This ensures that a diverse variety of cleaning agents can be used without any limitation and it ensures the long-term stability of the surface quality and optical properties in spite of a high number of cleaning cycles.

The at least one mineral glass or glass-ceramic panel or a glass or glass-ceramic panel in a lightweight composite panel has a transparency of greater than 80%, preferably greater than 85%, more preferably greater than 88%, particularly preferred greater than 90%. However, it can even have a transparency of greater than 91%.

The lightweight composite panel according to the invention is intended to ensure a high degree of protection against shards in the event of breakage; that is, no shards are to be scattered into the surroundings. For this reason, the at least one glass or glass-ceramic panel is combined with at least one organic layer, with observation of the thermal safety requirements. For better understanding, this at least one organic layer is to be referred to as “an organic layer A.”

This layer can be designed advantageously as an adhesive layer, which, in the event of breakage, holds together and tightly retains the broken pieces of the glass panel which, moreover, increase the elasticity and reliability of the lightweight composite panel.

In a preferred embodiment, it is of advantage to design the lightweight composite panel with a second glass or glass-ceramic panel, with the at least one organic layer being arranged between the one glass or glass-ceramic panel and the second glass or glass-ceramic panel.

This second glass panel, like the first glass panel, is composed of a mineral glass and, accordingly, like the first glass panel, can be composed of a lithium aluminum silicate glass, a soda-lime silicate glass, a borosilicate glass, an alkali aluminosilicate glass, or an alkali-free or alkali-poor aluminosilicate glass, in particular of a chemically and/or thermally hardened aluminosilicate glass, soda-lime silicate glass, borosilicate glass, alkali aluminosilicate glass, or alkali-free or alkali-poor aluminosilicate glass. Such glasses are obtained by means of a drawing method, such as a downdraw method, by means of overflow fusion, or by means of float technology.

In the case of design of a second panel of a glass-ceramic panel, the second panel is composed of a ceramicized aluminosilicate glass or lithium aluminosilicate glass, in particular of a chemically and/or thermally hardened ceramicized aluminosilicate glass or lithium aluminosilicate glass.

This second glass or glass-ceramic panel can be identical to the one glass or glass-ceramic panel, that is, to the first glass- or glass-ceramic panel, which serves as a base support panel.

In a preferred embodiment, however, the second glass- or glass-ceramic panel is thinner. For example it can be composed of a thin glass film, preferably made of an aluminosilicate glass or a borosilicate glass, which is also available as a rolled ribbon of thin glass. The thickness of the second glass- or glass-ceramic panel is less than or equal to 1000 μm, preferably less than or equal to 550 μm, more preferably less than or equal to 350 μm, particularly preferred less than or equal to 210 μm, and greater than or equal to 20 μm, preferably greater than or equal to 40 μm, more preferably greater than or equal to 70 μm, particularly preferred greater than or equal to 100 μm.

In order to prevent an undesired bending or bulging of the lightweight composite panel, the coefficients of thermal expansion of the two glass or glass-ceramic panels have to be tuned to each other. The difference of the coefficient of thermal expansion of the one glass- or glass-ceramic panel and that of the second glass- or glass-ceramic panel is less than or equal to 7×10⁻⁶ K⁻¹, preferably less than or equal to 5×10⁻⁶ K⁻¹, preferably less than or equal to 3×10⁻⁶ K⁻¹, preferably less than or equal to 2.5×10⁻⁶ K⁻¹, more preferably less than or equal to 2×10⁻⁶ K⁴, particularly preferred less than or equal to 1×10⁻⁶ K⁻¹.

In an embodiment, in order to improve further the elasticity and reliability of the lightweight composite panel, a second organic layer is provided in place of the second glass or glass-ceramic panel, with observation of the thermal safety requirements, whereby the at least one organic layer A is arranged between the one glass panel and the second organic layer. For better understanding, this second organic layer will be referred to as “organic layer D.”

In an advantageous embodiment, this second organic layer D is a polymer film. For applications in which good optical properties are essential, the polymer film has a transparency greater than 70%, preferably greater than or equal to 85%, more preferably greater than or equal to 88%, particularly preferred greater than or equal to 92%. For example, a polymer film made of PMMA in the given thickness range has a transparency of greater than or equal to 92%, a polymer film correspondingly made of PET has a transparency of greater than or equal to 88%, and a polymer film correspondingly made of PC has a transparency of greater than or equal to 85%. However, for other applications, above all in the field of architecture and furniture, this film can also be colored, translucent, or opaque in design or be a carrier of images or printing.

Such a polymer film has a thickness of less than or equal to 300 μm, preferably of less than or equal to 100 μm, more preferably of less than or equal to 50 μm, particularly preferred of less than or equal to 20 μm. In the choice of the thickness of the polymer film, the ratio of the total thickness of a glass or glass-ceramic panel to the total thickness of all of the organic layers, on which the invention is based, is observed; for example, the ratio of the thickness of the one glass or glass-ceramic panel to the sum total of the thickness of the organic layers A and D.

The polymer film is composed preferably of a polyethylene terephthalate (PET), a polycarbonate (PC), a polymethyl methacrylate (PMMA), a polyamide (PA), a polyimide (PI), or a polyolefin such as polyethylene (PE) or polypropylene or, in each case, a blend thereof, copolymers thereof, or derivatives thereof, or it is composed of a fluorinated and/or chlorinated polymer, such as, for example, ethylene-tetrafluoroethylene (ETFE), polytetrafluoroethylene (PTFE), polyvinyl chloride (PVC), polyvinylidene chloride (PVDC), polyvinylidene fluoride (PVDF), polyethylene naphthalate (PEN), or it is composed of a terpolymer made of tetrafluroethylene, hexafluoropropylene,and vinylidene fluoride (THV).

In another preferred embodiment, the lightweight composite panel comprises a second organic layer B and a third organic layer C, with the second organic layer B being a polymer film that is arranged between the first organic layer A and the third organic layer C. In an embodiment, the three organic layers A, B, and C are arranged between the one glass or glass-ceramic panel and the second glass or glass-ceramic panel. In another embodiment, they are arranged between the one glass or glass-ceramic panel and the second organic layer D, which, in this embodiment, would then be a fourth organic layer. The organic layers A and C are each designed above all as an adhesive layer, which permanently joins and adhesively bonds the elements or materials of the lightweight composite panel (first glass or glass-ceramic panel, second glass or glass-ceramic panel, polymer film, polymer film in respective combination) to one another and, in the event of breakage of the glass or glass-ceramic panel or the glass or glass-ceramic panels, the breakage fragments are held together and tightly retained in each case. Accordingly, they act as shard protection. Furthermore, the elasticity and reliability of the lightweight composite panel are increased by them. However, in order to improve still further the shard protection, the elasticity, and the reliability of the lightweight composite panel, another organic layer B in the form of a polymer film is arranged between the organic layers A and C.

The thickness of the polymer film is less than or equal to 100 μm, preferably less than or equal to 50 μm, more preferably less than or equal to 20 μm, particularly preferred less than or equal to 12 μm. In the choice of the thickness of the polymer film, the ratio of the total thickness of a glass or glass-ceramic panel to the total thickness of all of the organic layers, on which the invention is based, is observed—for example, the ratio of the thickness of the one glass or glass-ceramic panel to the sum total of the thickness of the organic layers A, B, and C.

The polymer film is composed preferably of a polyethylene terephthalate (PET), a polycarbonate (PC), a polymethyl methacrylate (PMMA), a polyamide (PA), a polyimide (PI), or a polyolefin such as polyethylene (PE) or polypropylene or, in each case, a blend thereof, copolymers thereof, or derivatives thereof, or it is composed of a fluorinated and/or chlorinated polymer, such as, for example, ethylene-tetrafluoroethylene (ETFE), polytetrafluoroethylene (PTFE), polyvinyl chloride (PVC), polyvinylidene chloride (PVDC), polyvinylidene fluoride (PVDF), polyethylene naphthalate (PEN), or it is composed of a terpolymer made of tetrafluroethylene, hexafluoropropylene, and vinylidene fluoride (THV).

The thickness of the one organic layer is less than or equal to 350 μm, preferably less than or equal to 200 μm, preferably less than or equal to 100 μm, more preferably less than or equal to 60 μm, particularly preferred less than 30 μm. The thickness organic layer C is less than or equal to 200 μm, preferably less than or equal to 100 μm, more preferably less than or equal to 60 μm, particularly preferred less than 30 μm. In the choice of the thickness of the organic layer A and/or the third organic layer C, the ratio of the total thickness of a glass or glass-ceramic panel to the total thickness of all of the organic layers, on which the invention is based, is observed.

The internal transmittance of the one organic layer A is greater than or equal to 88%, preferably greater than or equal to 92%, more preferably greater than or equal to 96%, particularly preferred greater than or equal to 99%. The internal transmittance of the one organic layer C is likewise greater than or equal to 88%, preferably greater than or equal to 92%, more preferably greater than or equal to 96%, particularly preferred greater than or equal to 99%.

The organic layer A or the organic layer C or both organic layers can be composed of a hot-melt adhesive, in the sense of an encapsulating or embedding material, in particular of a polyvinylbutyral (PVB) or a urethane-based thermoplastic elastomer (TPE-U) or an ionomer or a polyolefin, such as an ethylene vinyl acetate (EVA), or a polyethylene (PE) or a polyethylene acrylate (EA) or a cyclo-olefin copolymer (COC) as adhesive film or a thermoplastic silicone. In an especially preferred embodiment, the organic layer A or the organic layer C or both organic layers is or are composed of an organic low-molecular-weight compound, an adhesive film that is characterized by high optical transparency, a permanent adhesive capacity with respect to glass or glass ceramic, and an elasticity that is adequate for glass or glass ceramic for accommodation of the stress and for shard protection. This can be an adhesive tape, for example. The intermediate layer can be composed of an acrylate-based bonding adhesive film, in particular of an optically clear adhesive (OCA), such as the one offered, for example, by the 3M (Minnesota Mining and Manufacturing) company/St. Paul/Minnesota Mining and Manufacturing) company/St. Paul/Minnesota, USA, under the trade name 3M™ Optically Clear Adhesive or the one marked by the company tesa SE/D-Hamburg under the trade name tesa® OCA tesa 69xxx, for example, such as tesa 69301 to 69305 or tesa 69401 to 69405, for example.

In a preferred embodiment, in order to ensure the good optical properties of the lightweight composite panel for certain applications, such as, for example, as viewing windows for vehicle cabins, the refraction values of all of the elements or materials of a lightweight composite panel in the corresponding embodiment (first glass or glass-ceramic panel, second glass or glass-ceramic panel, polymer film, polymer film, adhesive layer in the respective combination) are to be tuned to one another. The difference in the refractive index of the materials arranged respectively in an embodiment of lightweight composite panel is less than or equal to 0.3, preferably less than or equal to 0.25, preferably less than or equal to 0.2, preferably less than or equal to 0.15, in particular less than or equal to 0.09. Thus, for example, typical refractive indices or refraction values for the first and/or second glass or glass-ceramic panel are 1.50 to 1.53 (at 588 or 633 nm) for an aluminosilicate glass or, in its compressive stress layer after a chemical prestressing, 1.51 to 1.54 (at 588 or 633 nm) or, for a borosilicate glass, 1.523 (at 588 nm) or, for an alkali-free aluminosilicate glass, 1.510 (at 588 nm) or, for a soda-lime glass, 1.52 (at 588 nm). The refractive index of the organic layer A or of the organic layer C as OCA is 1.47. The refractive index of the organic layer B or D as PET, for example, is 1.56 to 1.64 as reference value, as PC, for example, 1.58 as reference value, as PMMA, for example, 1.49 as reference value, as PE, for example, 1.50 to 1.54 as reference value, as PP, for example, 1.49 to 1.6 as reference value, as PA, for example, 1.53 as reference value, and as PI, for example, 1.66 to 1.78 as reference value.

For the determination of the thickness of the individual layers in a lightweight panel according to the invention, with observation of the ratio of the total thickness of the one or more glass or glass-ceramic panel or panels to the total thickness of all of the organic layers, the following reference values are given, for example: for an aluminosilicate glass, a density of 2.39 to 2.48 g/cm³; for a borosilicate glass, a density of 2.51 g/cm³; for an alkali-free aluminosilicate glass, a density of 2.43 g/cm³; for a soda-lime glass, a density of 2.5 g/cm³; for a lithium aluminosilicate glass ceramic, a density of 2.5 g/cm³; for an organic layer A or an organic layer C as OCA, a density of 1.05 g/cm³; for an organic layer B or an organic layer D as, for example, PET, a density of 1.3 to 1.4 g/cm³, as, for example, PC, a density of 1.2 g/cm³, as, for example. PMMA, a density of 1.19 g/cm³, as, for example. PE, a density of 0.92 to 0.95 g/cm³, as, for example, PP, a density of 0.9 g/cm³, as, for example, PA, a density of 1.13 g/cm³, as, for example, PI, a density of 1.42 g/cm³, as, for example, TPU, a density of 1.15 g/cm³.

The invention also includes a method for the manufacture of such a lightweight composite panel. As preferred manufacturing method, a method of the roller lamination process is used. The manufacturing method is carried out either as sheet to sheet process or as a roll to sheet process under cleanroom conditions.

In the case of a sheet-to-sheet process, a glass or glass-ceramic panel, which represents the base support substrate for the lightweight composite panel, is provided in a first step. This occurs in the form of a panel as stock size or final size. This glass or glass-ceramic panel is laid with its first face, which then constitutes an outer face in the lightweight composite panel, onto a solid base, which bears the panel and is introduced into the process chain. The base can be designed with another base, such as paper or a film made of polytetrafluoroethylene (PTFE), which runs through the process at the same time, in order to protect the glass or glass-ceramic panel and to facilitate subsequent process steps. In a second step, an organic layer A is provided, which is usually withdrawn from a roll. This is preferably an adhesively bonding film, in particular, for example, an OCA, with which the glass or glass-ceramic panel is adhesively bonded in a third step. To this end, a protective film, if present, is initially peeled off a first face of the adhesive film, which is then placed onto the glass or glass-ceramic panel. Such a protective film can be, for example, a PET film with a thickness of 50 μm. This occurs continuously with the adhesive bonding process with the feed of the roll. This first face of the adhesive film is rolled flat onto the exposed top side of the glass or glass-ceramic panel by means of a roller. Preferably, the roller for pressing on the organic layer A is rubberized so as to suppress peaks in pressure as pressing occurs onto the laminate. Furthermore, the roller is treated during pressing. Here, a heating of greater than 25° C., in particular greater than or equal to 45° C. is appropriate in order to prevent in large part or entirely any creation of streaks in the laminate. The pressing of air out of the joint gap is assisted during heating, because the organic layer becomes softer.

Preferably, the organic layer A is rolled out so as to overhang the glass or glass-ceramic panel. In order to prevent any disruptions of the further process entailed by adhesive attachment of the adhesive film that projects over the glass or glass-ceramic panel to the transport system or any other point of contact, the laminate is transported on co-running paper or an appropriate base throughout the entire manufacturing process.

In a fourth process step, a protective film is peeled off the second, now exposed face of the organic layer A. Such a protective film can likewise be, for example, a PET film with a thickness of 50 or 125 μm, with the adhesive attachment of the protective film to the second face of the organic layer A being greater than it is to its first face.

In a fifth step that then follows, the second glass or glass-ceramic panel or, depending on the embodiment, instead of the glass or glass-ceramic panel, the organic layer D is supplied and placed on the exposed second face of the organic layer A. This occurs as stock size or final size in panel form or as thin glass or polymer ribbon wound on a roll. The thin glass panel or the material for the organic layer D is fed from above over an inclined plane and brought into contact with the surface of the organic layer A. Initially, the second glass or glass-ceramic panel or the material for the organic layer D is positioned via a stop system. If a linear contact along the front edge of the first glass or glass-ceramic panel is created with a tight fit, then the stop system opens and releases the further transport path. The rolling out of the thin glass or of the material for the organic layer D onto the face of the first glass or glass-ceramic panel coated with the organic layer A then occurs. When the second glass or glass-ceramic panel or the material for the organic layer D is applied from the inclined feed plane onto the surface of the adhesive film, a closing angle is present, which is defined by a deflection of the second glass or glass-ceramic panel or of the material for the organic layer D prior to its application. For rolling of the second glass or glass-ceramic panel or of the material for the organic layer D, the pressing roller is preferably rubberized and also heated. Here, too, a heating of greater than 25° C., in particular greater than or equal to 45° C., is appropriate. In order to enable also the processing of different glass or glass-ceramic thicknesses or polymer film thicknesses, this roller is preferably mounted on a spring suspension. When a glass or glass-ceramic roll or polymer film roll is used for supplying the second glass or glass-ceramic panel or the material for the organic layer D, the respective ribbon is cut to size after it has covered the desired face. Conventional methods, such as cutting with a glass cutter or a knife or by laser scoring, are used for this.

In another embodiment, in place of the organic layer A, a composite composed of a first organic layer A, a second organic layer B, and a third organic layer C or a composite composed of further additional organic layers is rolled onto the first glass or glass-ceramic panel. In this process, the composite of the three organic layers A, B, and C or a composite composed of further organic layers is deposited layer by layer onto the first glass or glass-ceramic panel. In a preferred embodiment of the method, the composite is prefabricated separately in each case and rolled onto the first glass or glass-ceramic panel as a prefabricated composite correspondingly alternatively to the organic layer A.

In another embodiment, in place of the organic layer A, a composite composed of a first organic layer A and a second organic layer D is rolled onto the first glass or glass-ceramic panel. In this process, the composite of the two organic layers A and D is prefabricated separately and rolled onto the glass or glass-ceramic panel as a prefabricated composite. The application of a second glass or glass-ceramic panel or a second organic layer D subsequent to this as a separate step is thus dispensed with in this embodiment.

Above all, in another preferred embodiment, when a hot-melt adhesive in the sense of an encapsulating or embedding material is used, in particular for the organic layer A, for one of the organic layers, but also for increasing the quality of the lightweight composite panel in all other embodiments, the laminate of the lightweight composite panel is post-treated in a further step after application or pressing on of the second glass or glass-ceramic panel or of the organic layer D. In this further process step, which can occur separately from the preceding process steps, the method is conducted in such a way that the organic layer melts and/or is cross-linked and hardened. For this, the post-treatment by means of heating is carried out at a temperature preferably in the range of 120° C. to 160° C. within a time period of up to 6 hours and, if need be, assisted by a vacuum and/or pressure, preferably at 5 to 15 kg/cm². Preferably, this post-treatment step is carried out with the use of an autoclave.

In a further step, the organic layer A is cut flush with the edges of the glass or glass-ceramic panel or else lightweight composite panels are cut from the laminate in final size.

The invention further also includes the use of such a lightweight composite panel. In particular, such a lightweight composite panel is suitable as a furnishing element for vehicle cabins in the field of transportation, in particular for vehicle cabins of an aircraft or an electric vehicle, but also for applications in boats or other means of transportation. In comparison to the panels known in prior art, the lightweight composite panels according to the invention enable applications where, besides a low weight per unit area, a high scratch resistance, a high surface hardness, a high surface quality, a good chemical resistance toward cleaning agents, and very good fire protection properties, such as flammability, flame retardancy, or smoke barriers, are crucial, depending on the respective embodiments as described above.

In the especially preferred embodiment with a low weight per unit area, a high scratch resistance, a high surface hardness, a good chemical resistance toward cleaning agents, and, still further, a high optical transparency and very good optical properties, such as, for example, the absence of streaks and a very low haze, as described respectively above, combined with compliance with the required properties of high fire protection, the lightweight composite panel according to the invention enables applications as a window or door element or a component of a window or of a door or as a partition or as a table element or component of a table, such as, for example, a folding table in the area of air travel, where especially stringent requirements are posed. Through meeting all of these requirements, as established in the official guidelines and regulations, such as those of the FAA, RTCA, EASA, or the specifications of aircraft manufacturers, the use as furnishing element for an aircraft is afforded. On account of the low weight per unit area in conjunction with all of the good properties, the invention relates also to the use as a furnishing element for vehicle cabins in the field of transportation, in particular, in addition to vehicle cabins for an aircraft, also those for an electric vehicle. In the process, the invention relates above all to the use as a window or door element or as a component of a window or of a door or as a partition or as a table element. Partitions are employed in order to separate certain passenger areas from one another. As a table element, the lightweight composite panel can be a component of a folding table, such as one commonly used in aircraft.

Of special advantage is the use of the lightweight composite panel as an interior window pane of an aircraft or electric vehicle. In the event a fire, there is no danger of accelerating the fire and no associated danger to a passenger arising from the panel.

The invention also comprises an interior aircraft window pane or lightweight window pane with a lightweight composite panel according to the invention in accordance with one of the above embodiments or in accordance with a combination thereof. In an embodiment, the interior aircraft window pane or lightweight window pane further comprises, in addition to the lightweight composite panel, a frame, which is tightly joined to the lightweight composite panel. In a preferred embodiment, the frame is adhesively attached to the lightweight composite panel. In this case, the first glass or glass-ceramic panel, which serves as base support substrate of the lightweight composite panel, is wider than the second glass or glass-ceramic panel, so that a free overhang is formed. The frame is mounted on the overhanging face of the first glass or glass-ceramic panel. In an advantageous embodiment, the organic layer A serves in this case as an adhesive film on the first glass or glass-ceramic panel also for fastening of the frame.

The frame has an outer geometry that is defined for the installation of the window pane or the interior aircraft window pane. It is provided by a frame designed from aluminum or a suitable polymer, said frame protecting the edges of the lightweight composite panel used and enabling the window to be installed in defined position in the aircraft, in the vehicle, or in the field of architecture through additional positioning aids. The frame is adhesively attached to the lightweight composite by using, for example, an exposed face of the glass or glass-ceramic panel, which is furnished with the organic layer A as an adhesive film—for example, with an OCA—as a joining area. In this case, the first glass or glass-ceramic panel, which serves as base support substrate of the lightweight composite panel, is correspondingly designed to be wider than the second glass or glass-ceramic panel.

In another embodiment without a frame, the lightweight composite panel can be fitted with a corresponding holder and mounted in the component bearing the lightweight window pane. Such a component can be a wall, for example.

The invention further comprises the use of a lightweight composite panel as a lightweight fire protection component in the field of architecture, in particular as a smoke barrier element, partition, a window element, a door element, a wall element, or a ceiling element, or as a component of a window, a door, a wall, or a ceiling, as a showcase panel, or as a component of a piece of furniture.

The invention also comprises a smoke barrier element with a lightweight composite panel according to the invention in accordance with one of the preceding embodiments or in accordance with a combination thereof. Such lightweight composite panels according to the invention as smoke barrier elements are mounted vertically 20 to 100 cm, for example, suspended from the ceiling in order to impede any spread or transmission of smoke in a room in the event of fire. A danger in the event of fires often ensues from the spread of smoke in buildings, entailing the danger of smoke poisoning for persons. Such fire-protection-safe, lightweight smoke barrier elements enable the time for danger-free evacuation in the case of fire to be markedly prolonged. Owing to the low weight of the lightweight composite panels and the high fire protection thereof, it is possible to provide a solution with less static load of the construction and hence lower costs.

### BRIEF DESCRIPTION OF THE DRAWINGS

The invention is to be explained in detail by way of the following examples.

FIG. 1 shows a lightweight composite panel with a 3-layer construction;

FIG. 2 shows a typical curve of the heat release rate for a lightweight composite panel according to FIG. 1;

FIG. 3 shows a lightweight composite panel with a 5-layer construction;

FIG. 4 shows a lightweight composite panel with a 3-layer construction; and

FIG. 5 shows a window pane with lightweight composite panel and frame.

### DETAILED DESCRIPTION

In a first comparison example, a 3-layer composite panel was fabricated from a first glass panel made of a chemically prestressed aluminosilicate glass, such as the one offered, for example, by the company Schott AG/Mainz under the trade name Xensation® Cover, which has a thickness of 0.55 mm and a density of 2.48 g/cm³; as an organic layer, an interlayer made of a thermoplastic polyurethane elastomer (TPU), which has a thickness of 380 μm and a density of 1.15 g/cm³, was used and, as a second glass panel, a thin glass film made of a non-prestressed borosilicate glass, such as the one offered, for example, by the company Schott AG/Mainz under the trade name D 263® T, which has a thickness of 0.21 mm and a density of 2.51 g/cm³. Although a weight per unit area of 2.33 kg/m² resulted, which lies just below the value of 2.4 kg/cm² of a pure PC or PMMA window pane in an aircraft interior cabin, this composite panel as comparison example did not pass the Bunsen burner test. This test was carried out in accordance with the provisions and regulations of FAR/JAR/CS 25, App. F, Part I. Although, in this case, a ratio of the thickness of the two glass panels to the thickness of the organic layer of 1:0.5 resulted, the organic layer thickness was as such too great in order to pass the Bunsen burner test.

In a second comparison example, a 5-layer composite panel was fabricated from a first glass panel made of a non-prestressed borosilicate glass corresponding to the second glass panel of Comparison Example 1; as organic layer A, an OCA, such as the one offered by the company tesa SE/D-Hamburg under the trade name tesa® OCA tesa 69402, which has a thickness of 50 μm and a density of 1.05 g/cm³, was used and, as organic layer B, a flame-protected polycarbonate was used as polymer film, such as the one offered, for example, by the company Evonik Industries AG/D-Darmstadt under the trade name Europlex® F7, which has a thickness of 1500 μm and a density of 1.2 g/cm³; as third organic layer C, an OCA corresponding to organic layer A was used and, as glass panel, a thin glass film corresponding to the first glass panel was used. Although a weight per unit area of 2.96 kg/m² resulted, which is still not very much above the value of 2.4 kg/m² as reference value for a pure PC or PMMA window pane in an aircraft inner cabin, this composite panel, as comparison example, did not pass the test of total heat release. This test was carried out in accordance with the provisions and regulations of FAR/JAR/CS 25, App. F, Part IV & AITM 2.0006. The ratio of the thickness of the two glass panels to the thickness of the three organic layers of 1:3.810 was markedly too high, so that, in comparison to a pure PC panel, there resulted no marked difference with respect to the total heat release.

The following examples show that only the observation of the specific limits of the total thickness of all of the organic layers and the ratio of the total thickness of the one or more glass panels to the total thickness of all of the organic layers enables an adequate thermal safety to be realized in an inventive way for the lightweight composite panel, above all in regard to the flame behavior according to the Bunsen burner test and in regard to the total heat release according to the test of heat release.

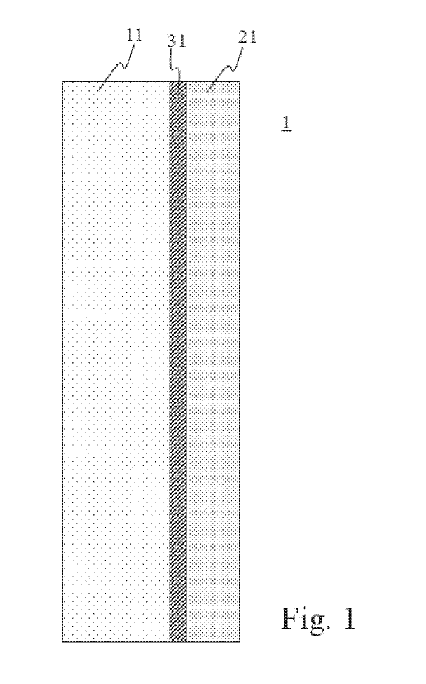

FIG. 1 shows, in a first example, the structure of a 3-layer lightweight composite panel 1. The base support substrate is formed by a first glass panel 11 made of a chemically prestressed aluminosilicate glass, such as the one offered by the company Schott AG/Mainz under the trade name Xensation® Cover, which has a thickness of 0.55 mm and a density of 2.48 g/cm²; as the organic layer A 31, an OCA, such as the one offered by the company tesa SE/D-Hamburg under the trade name tesa® OCA tesa 69402, which has a thickness of 50 μm and a density of 1.05 g/cm³, was used and, as a second glass panel 21, a thin glass film made of a non-prestressed borosilicate glass, such as the one marked by the company Schott AG/Mainz under the trade name D 236® T, which has a thickness of 0.21 mm and a density of 2.51 g/cm², was used. A weight per unit area of 1.99 kg/m² resulted and hence a weight savings of 18% in comparison to a standard window pane made of pure PC or PMMA in an aircraft interior cabin with 2.4 kg/cm² as reference value. The ratio of the thickness of the two glass panels to the thickness of the organic layer was 1:0.066.

This lightweight composite panel 1 passed the Bunsen burner test, which was carried out in compliance with the provisions and regulations of FAR/JAR/CS 25, App. F, Part I & AITM 2.0002A. The sample edge was exposed to the burner flame for 60 seconds in each case. The flame time after removal of the flame was 0 s for all samples (less than 15 s is required). The drip flame time was 0 sec for all samples (less than 3 s is required); no dripping of material was observed in the tests. The burn length was 83 mm on average for 3 samples (less than 152 mm is required). The burn length is defined in this case by the distance from the original sample edge to the remotest site of destruction due to burning, partial destruction, or embrittlement of this site.

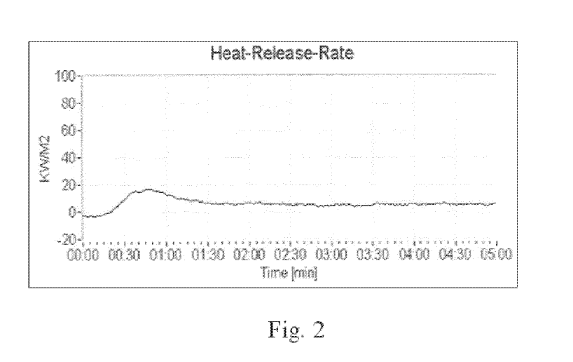

This lightweight composite panel 1 also passed the heat release test. This test was carried out in compliance with the provisions and regulations of FAR/JAR/CS 25, App. F, Part IV & AITM 2.0006. FIG. 2 shows a typical curve of the heat release rate for a sample made of a lightweight composite panel 1 according to this example. The test is a calorimetric measurement, which measures the heat release of a material over a time period of 5 min in the event of a fire. The heat release rate is a value for the amount of energy that is released when the material burns most strongly, this being clear from the peak of the curve. The averaged value of 3 samples may not exceed 65 kW/m² over a time period of 5 min. The integral over the first 2 min characterizes the value of the total heat release, which may not exceed 65 kW×min/m² averaged over 3 samples. The heat release rate is a measure of the amount of energy that is released by the sample material in the event of a fire. The lightweight composite panel 1 had a heat release rate of 17.53 kW/m² and a total heat release of 13.54 kW×min/m².

The following Examples 2 and 3 show alternative embodiments of a lightweight composite panel that passed the Bunsen burner test and the heat release test.

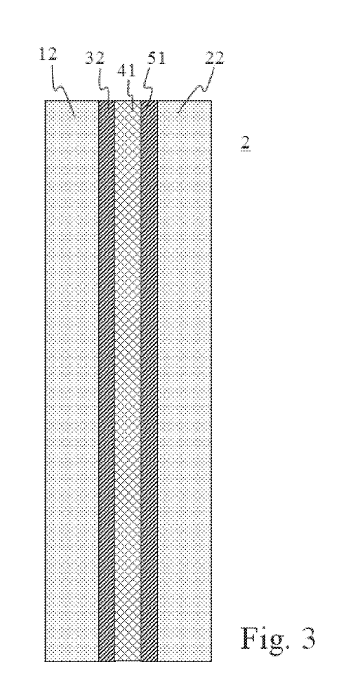

FIG. 3 shows for a second example the structure of a 5-layer lightweight composite panel 2. The base support substrate is formed by a first glass panel 12 made of a thin glass film composed of a non-prestressed borosilicate glass, such as the one offered by the company Schott AG/Mainz under the trade name D 263® T, which has a thickness of 0.21 mm and a density of 2.51 g/cm². Alternatively, it is possible also to use a chemically prestressed borosilicate glass or else, for example, an aluminosilicate glass. As the organic layer A 32, an OCA, such as the one offered by the company tesa SE/D-Hamburg under the trade name tesa® OCA tesa 69402, which has a thickness of 50 μm and a density of 1.05 g/cm³, was used. As the organic layer B 41, a PET film with a thickness of 12 μm and a density of 1.05 g/cm³ was used. As the organic layer C 51, an OCA, such as the one offered by the company tesa SE/D-Hamburg under the trade name tesa® OCA tesa 69402, which has a thickness of 50 μm and a density of 1.05 g/cm³, was used. As the second glass panel 22, a thin glass film made of a non-prestressed borosilicate glass, such as the one marked by the company Schott AG/Mainz under the trade name D 236® T, which has a thickness of 0.21 mm and a density of 2.51 g/cm², was used. Alternatively, it is also possible to use here a chemically prestressed borosilicate glass or else, for example, an aluminosilicate glass. A weight per unit area of 1.17 kg/m² resulted and hence a weight savings of 51% in comparison to a standard window pane made of pure PC or PMMA in an aircraft interior cabin with 2.4 kg/cm² as reference value. The ratio of the thickness of the two glass panels to the total thickness of the organic layer of 112 μm was 1:0.267.

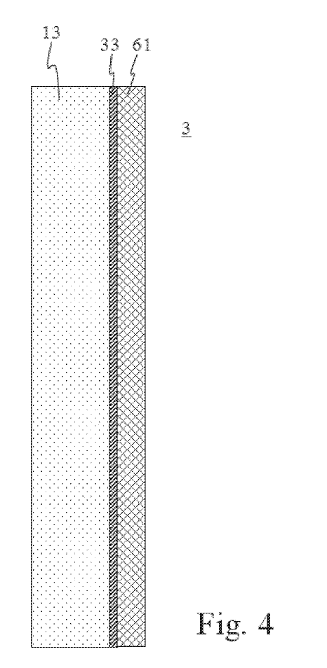

FIG. 4 shows for Example 3A another structure of a 3-layer lightweight composite panel 3. The base support substrate is formed by a first glass panel 13 made of a chemically prestressed aluminosilicate glass, such as the one offered by the company Schott AG/Mainz under the trade name Xensation® Cover, which has a thickness of 0.7 mm and a density of 2.48 g/cm²; as the organic layer A 33, an OCA, such as the one offered by the company tesa SE/D-Hamburg under the trade name tesa® OCA tesa 69401, which has a thickness of 25 μm and a density of 1.05 g/cm³, was used. As the second organic layer D 61, a PET film with a thickness of 100 μm and a density of 1.05 g/cm³ was used. A weight per unit area of 1.88 kg/m² resulted and hence a weight savings of 21% in comparison to a standard window pane made of pure PC or PMMA in an aircraft interior cabin with 2.4 kg/cm² as reference value. The ratio of the thickness of the two glass panels to the total thickness of the organic layers of 125 μm was 1:0.179.

Alternatively to Example 3A, another Example 3B is given as structure of a S-layer lightweight composite panel 3. The base support substrate is again formed by a first glass panel 13 made of a chemically prestressed aluminosilicate glass, such as the one offered by the company Schott AG/Mainz under the trade name Xensation® Cover, which has a thickness of 0.55 mm and a density of 2.48 g/cm². As the organic layer A 33, an OCA, such as the one offered by the company tesa SE/D-Hamburg under the trade name tesa® OCA tesa 69401, which has a thickness of 25 μm and a density of 1.05 g/cm³, was used. As the second organic layer D 61, a PET film with a thickness of 36 μm and a density of 1.2 g/cm³ was used. A weight per unit area of 1.43 kg/m² resulted and hence a weight savings of 40% in comparison to a standard window pane made of pure PC or PMMA in an aircraft interior cabin with 2.4 kg/cm² as reference value. The ratio of the thickness of the two glass panes to the total thickness of the organic layers of 61 μm was 1:0.111. A testing of the flame time corresponding to the “vertical Bunsen burner test” in compliance with the stipulations and test conditions of the FAA in accordance with the “Aircraft Materials Fire Test Handbook,” DOT/FAA/AR-00/12, Chapter 1 “Vertical Bunsen Burner Test for Cabin and Cargo Compartment Materials,” resulted in this case, after removal of the flame in the test, measured in compliance with FAR/JAR/CS 25, App. F, Part I, in a flame time of less than 1 to 0 seconds owing to the self-extinguishing behavior of the layer structure. The transparency of the lightweight composite panel was 90.1% and the optical scattering behavior (haze) was 0.66%. The refractive index of the glass panel 13 was 1.51 (at 588 nm), the refractive index of the two organic layers as precomposite was 1.48 (at 5.88 nm). The difference in the refractive indices was thus 0.3. The first organic layer A and the second organic layer D were joined to each other in a precomposite and then rolled onto the glass pane without any bubbles in a cleanroom. The roller was heated to a temperature of 28° C.

The following examples 4 to 12 show further alternative embodiments of a lightweight composite panel corresponding to the embodiments of FIGS. 1 to 4, which passed the Bunsen burner test and the heat release test.

### EXAMPLE 4

| | Material | Thickness | |
|---|---|---|---|
| Glass layer | Chemically prestressed aluminosilicate | 0.55 | mm |
| | glass | | |
| Organic layer | OCA | 50 | μm |
| A | | | |
| Second glass | Chemically prestressed aluminosilicate | 0.55 | mm |
| layer | glass | | |

Weight per unit area: 2.78 kg/m².

Total thickness of the organic layers: 50 μm.

Ratio of the thickness of the glass panel to the total thickness of the organic layers: 1:0.045.

### EXAMPLE 5

| | Material | Thickness | |
|---|---|---|---|
| Glass layer | Chemically prestressed aluminosilicate | 1.0 | mm |
| | glass | | |
| Organic layer | Interlayer TPU | 350 | μm |
| A | | | |
| Second glass | Chemically prestressed borosilicate | 0.7 | mm |
| layer | glass | | |

Weight per unit area: 4.61 kg/m².

Total thickness of the organic layers: 350 μm.

Ratio of the thickness of the glass pane to the total thickness of the organic layers: 1:0.206.

### EXAMPLE 6

| | Material | Thickness | |
|---|---|---|---|
| Glass | Chemically prestressed aluminosilicate glass | 0.55 | mm |
| layer | | | |
| Organic | Interlayer made of silicone-based, highly | 200 | μm |
| layer A | transparent plastic film, such as the one offered | | |
| | by the company Wacker Chemie AG/D-Munich | | |
| | under the trade name Tectosil ® | | |
| Second | Chemically non-prestressed borosilicate glass | 0.21 | mm |
| glass | | | |
| layer | | | |

Weight per unit area: 2.10 kg/m².

Total thickness of the organic layers: 200 μm.

Ratio of the thickness of the glass pane to the total thickness of the organic layers: 1:0.263.

### EXAMPLE 7

| | Material | Thickness | |
|---|---|---|---|
| Glass layer | Chemically non-prestressed borosilicate glass | 0.2 | mm |
| Organic | OCA | 25 | μm |
| layer A | | | |
| Second glass | Chemically non-prestressed aluminosilicate | 0.05 | mm |
| layer | glass | | |

Weight per unit area: 0.65 kg/m².

Total thickness of the organic layers: 25 μm.

Ratio of the thickness of the glass pane to the total thickness of the organic layers: 1:0.10.

### EXAMPLE 8

| | Material | Thickness | |
|---|---|---|---|
| Glass layer | Chemically prestressed aluminosilicate glass | 1.0 | mm |
| Organic | OCA | 125 | μm |
| layer A | | | |
| Second glass | Chemically non-prestressed borosilicate glass | 1.0 | mm |
| layer | | | |

Weight per unit area: 5.12 kg/m².

Total thickness of the organic layers: 125 μm.

Ratio of the thickness of the glass pane to the total thickness of the organic layers: 1:0.063.

### EXAMPLE 9

| | Material | Thickness | |
|---|---|---|---|
| Glass layer | Chemically prestressed aluminosilicate glass | 0.2 | mm |
| Organic | OCA | 25 | μm |
| layer A | | | |
| Organic | PET film | 12 | μm |
| layer B | | | |
| Organic | OCA | 25 | μm |
| layer C | | | |
| Second glass | Chemically non-prestressed borosilicate glass | 0.025 | mm |
| layer | | | |

Weight per unit area: 0.63 kg/m².

Total thickness of the organic layers: 62 μm.

Ratio of the thickness of the glass pane to the total thickness of the organic layers: 1:0.276.

### EXAMPLE 10

| | Material | Thickness | |
|---|---|---|---|
| Glass layer | Chemically prestressed aluminosilicate glass | 1.0 | mm |
| Organic | OCA | 50 | μm |
| layer A | | | |
| Organic | PET film | 100 | μm |
| layer B | | | |
| Organic | OCA | 50 | μm |
| layer C | | | |
| Second glass | Chemically non-prestressed borosilicate glass | 1.0 | mm |
| layer | | | |

Weight per unit area: 5.22 kg/m².

Total thickness of the organic layers: 200 μm.

Ratio of the thickness of the glass pane to the total thickness of the organic layers: 1:0.10.

### EXAMPLE 11

| | Material | Thickness | |
|---|---|---|---|
| Glass layer | Chemically prestressed aluminosilicate glass | 1.0 | mm |
| Organic | OCA | 25 | μm |
| layer A | | | |
| Second glass | Chemically non-prestressed borosilicate glass | 1.0 | mm |
| layer | | | |

Weight per unit area: 5.02 kg/m².

Total thickness of the organic layers: 25 μm.

Ratio of the thickness of the glass pane to the total thickness of the organic layers: 1:0.013.

### EXAMPLE 12

| | Material | Thickness | |
|---|---|---|---|
| Glass layer | Chemically prestressed aluminosilicate glass | 0.35 | mm |
| Organic | OCA | 125 | μm |
| layer A | | | |
| Organic | PET film | 100 | μm |
| layer B | | | |
| Organic | OCA | 125 | μm |
| layer C | | | |
| Second glass | Chemically non-prestressed borosilicate glass | 0.025 | mm |
| layer | | | |

Weight per unit area: 1.31 kg/m².

Total thickness of the organic layers: 350 μm.

Ratio of the thickness of the glass pane to the total thickness of the organic layers: 1:0.933.

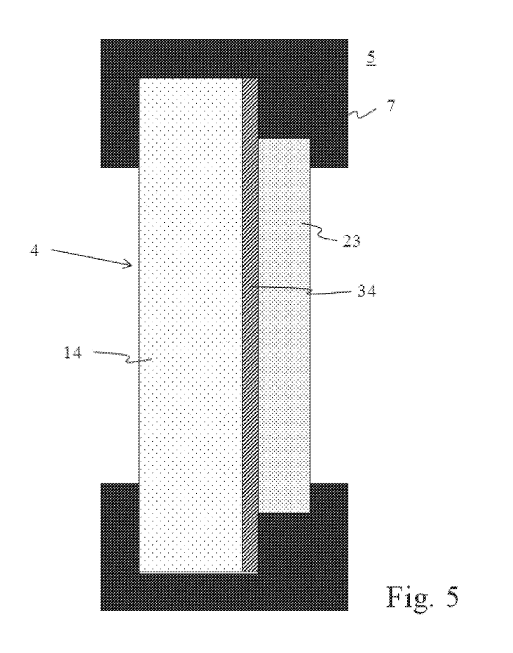

FIG. 5 shows a window pane 5 according to the invention, which comprises a lightweight composite panel 4 and a frame 7. The lightweight composite panel 4 can be composed of a glass panel 14 and a second glass panel 23 as well as an organic layer A 34. However, it can also have any other embodiment. The frame 7 and the lightweight composite panel 4 are joined to each other according to the invention by adhesively bonding the frame 7 to the glass panel 14 through the organic layer A 34 or, in other embodiments, the organic layer C. For this, the second glass panel 23 is correspondingly recessed, so that the adhesive film, in the form of the organic layer A 34, or, in other embodiments, the organic layer C overhangs so as to receive the joint area of the frame. Other parts of the frame can be bonded to the adhesively attached part of the frame, as is general knowledge of the person skilled in the art.

It is self-evident that the invention is not limited to a combination of the above-described features, but that the person skilled in the art can combine at will all features of the invention, insofar as this is reasonable, or else use them individually without departing from the scope of the invention.

LIST OF REFERENCE NUMBERS:

| | |
|---|---|
| 1, 2, 3, 4 | Embodiments of a lightweight composite panel |
| 5 | Window pane with a lightweight composite panel and |
| | frame |
| 11, 12, 13, 14 | Glass panel |
| 21, 22, 23 | Second glass panel |
| 31, 32, 33, 34 | Organic layer A |
| 41 | Second organic layer B |
| 51 | Third organic layer C |
| 61 | Second organic layer D |
| 7 | Frame |

What is claimed is:

1. A lightweight composite panel, comprising:
at least one mineral glass or glass-ceramic panel;
at least one organic layer;
a weight per unit area having a lower limit of 0.5 kg/m² and an upper limit of 5.5 kg/m²;
a ratio of a total thickness of all panels in the at least one panel to a total thickness of all layers in the at least one organic layer is 1:0.01 to 1:1, wherein the total thickness of all layers in the at least one organic layer is less than or equal to 450 μm; and
an absolute heat release, measured in compliance with JAR/FAR/CS 25, App. F, Part IV & AITM 2.0006, of less than 65 kW×min/m².

2. The lightweight composite panel according to claim 1, wherein the lower limit is greater than or equal to 1 kg/m², the upper limit is less than or equal to 3 kg/m², the ratio is 1:0.01 to 1:0.9, the total thickness of all layers in the at least one organic layer is less than or equal to 350 μm, and the absolute heat release of less than 50 kW×min/m².

3. The lightweight composite panel according to claim 1, further comprising a fire protection property with a flame time after removal of the flame in the vertical Bunsen burner test, measured in compliance with FAR/JAR/CS 25, App. F, Part I, of less than 15 s.

4. The lightweight composite panel according to claim 1, further comprising a transparency of greater than 80%.

5. The lightweight composite panel according to claim 1, further comprising an optical scattering behavior of less than or equal to 1.5%.

6. The lightweight composite panel according to claim 1, wherein the total thickness of all panels in the at least panel is less than or equal to 1 mm and greater than or equal to 200 μm.

7. The lightweight composite panel according to claim 1, wherein the at least one panel comprises a mineral glass panel selected from the group consisting of a lithium aluminum silicate glass, a soda-lime silicate glass, a borosilicate glass, an alkali aluminosilicate glass, an alkali-free aluminosilicate glass, a low-alkali aluminosilicate glass, a chemically hardened lithium aluminum silicate glass, a chemically hardened soda-lime silicate glass, a chemically hardened borosilicate glass, a chemically hardened alkali aluminosilicate glass, a chemically hardened alkali-free aluminosilicate glass, a chemically hardened low-alkali aluminosilicate glass, a thermally hardened lithium aluminum silicate glass, a thermally hardened soda-lime silicate glass, a thermally hardened borosilicate glass, a thermally hardened alkali aluminosilicate glass, a thermally hardened alkali-free aluminosilicate glass, and a thermally hardened low-alkali aluminosilicate glass.

8. The lightweight composite panel according to claim 1, wherein the at least one panel comprises a mineral glass-ceramic panel selected from the group consisting of a ceramicized aluminosilicate glass, a lithium aluminosilicate glass, a chemically hardened ceramicized aluminosilicate glass, a chemically hardened ceramicized lithium aluminosilicate glass, a thermally hardened ceramicized aluminosilicate glass, and a thermally hardened ceramicized lithium aluminosilicate glass.

9. The lightweight composite panel according to claim 8, wherein the panel is a chemically hardened panel having an ion-exchange depth of greater than or equal to 30 μm.

10. The lightweight composite panel according to claim 1, wherein the at least one panel has a surface compressive stress greater than or equal to 500 MPa.

11. The lightweight composite panel according to claim 1, wherein the at least one panel has an internal tensile stress of less than or equal to 50 MPa.

12. The lightweight composite panel according to claim 1, wherein the at least one panel has a 4-point bending strength of greater than or equal to 550 MPa.

13. The lightweight composite panel according to claim 1, wherein the at least one panel has a Young modulus of greater than or equal to 68 GPa.

14. The lightweight composite panel according to claim 1, wherein the at least one panel has a sheer modulus of greater than or equal to 25 GPa.

15. The lightweight composite panel according to claim 1, wherein the at least one panel has a Vickers hardness, in a non-prestressed state, of greater than or equal to 500 HV 2/20.

16. The lightweight composite panel according to claim 1, wherein the at least one panel has a Vickers hardness, in a prestressed state, of greater than or equal to 550 HV 2/20.

17. The lightweight composite panel according to claim 1, wherein the at least one panel comprises two mineral glass or glass-ceramic panels, and the at least one organic layer being arranged between the two panels.

18. The lightweight composite panel according to claim 17, wherein one of the two panels comprises a thin glass film made of an aluminosilicate glass or a borosilicate glass.

19. The lightweight composite panel according to claim 18, wherein the thin glass film has a thickness that is less than or equal to 1000 μm and greater than or equal to 20 μm.

20. The lightweight composite panel according to claim 17, wherein the two glass panels have a difference between coefficients of thermal expansion of is less than or equal to 7×10⁻⁶ K⁻¹.

21. The lightweight composite panel according to claim 1, wherein the at least one organic layer comprises two organic layers, a first of the two organic layers is arranged between the at least one panel and a second of the two organic layers.

22. The lightweight composite panel according to claim 21, wherein the second of the two organic layers is a polymer film.

23. The lightweight composite panel according to claim 22, wherein the polymer film has a transparency that is greater than 70%.

24. The lightweight composite panel according to claim 22, wherein the polymer film has a thickness of less than or equal to 300 μm.

25. The lightweight composite panel according to claim 22, wherein the polymer film is selected from the group consisting of a polyethylene terephthalate (PET), a polycarbonate (PC), a polymethyl methacrylate (PMMA), a polyamide (PA), a polyimide (PI), a polyolefin, polyethylene (PE), polypropylene, a fluorinated polymer, chlorinated polymer, ethylene-tetrafluoroethylene (ETFE), polytetrafluoroethylene (PTFE), polyvinyl chloride (PVC), polyvinylidene chloride (PVDC), polyvinylidene fluoride (PVDF), polyethylene naphthalate (PEN), a terpolymer made of tetrafluroethylene, a terpolymer made of hexafluoropropylene, and a terpolymer made of vinylidene fluoride (THV).

26. The lightweight composite panel according to claim 17, wherein the at least one organic layer comprises three organic layers, a second of the three organic layers comprising a polymer film arranged between a first and a third of the three organic layers, the three organic layers being arranged between the two panels.

27. The lightweight composite panel according to claim 26, wherein the polymer film has a thickness of less than or equal to 100 μm.

28. The lightweight composite panel according to claim 26,wherein the polymer film is selected from the group consisting of a polyethylene terephthalate (PET), a polycarbonate (PC), a polymethyl methacrylate (PMMA), a polyamide (PA), a polyimide (PI), a polyolefin, polyethylene (PE), polypropylene, a fluorinated polymer, chlorinated polymer, ethylene-tetrafluoroethylene (ETFE), polytetrafluoroethylene (PTFE), polyvinyl chloride (PVC), polyvinylidene chloride (PVDC), polyvinylidene fluoride (PVDF), polyethylene naphthalate (PEN), a terpolymer made of tetrafluroethylene, a terpolymer made of hexafluoropropylene, and a terpolymer made of vinylidene fluoride (THV).

29. The lightweight composite panel according to claim 26, wherein the first of the three organic layers has thickness that is less than or equal to 350 μm.

30. The lightweight composite panel according to claim 26, wherein the third of the three organic layers has a thickness of less than or equal to 200 μm.

31. The lightweight composite panel according to claim 26, wherein the first and/or the third of the three organic layers has an internal transmittance of greater than or equal to 88%.

32. The lightweight composite panel according to 26, wherein the first and/or the third of the three organic layers comprises a hot-melt adhesive made of a material selected from the group consisting of a polyvinylbutyral (PVB), a urethane-based thermoplastic elastomer (TPE-U), an ionomer, a polyolefin, an ethylene vinyl acetate (EVA), a polyethylene (PE), a polyethylene acrylate (EA), a cyclo-olefin copolymer (COC), a thermoplastic silicone, and an optically clear adhesive (OCA).

33. The lightweight composite panel according to claim 1, wherein the at least one panel and the at least one organic layer have a difference in refractive index of less than or equal to 0.3.

34. A method for the manufacture of a lightweight composite panel, comprising the steps of:
providing a first glass or glass-ceramic panel, wherein the first glass or glass-ceramic panel lies with a first face on a base;
providing a first organic layer;
peeling off any protective film present from a first face of the first organic layer;
rolling of the first face of the first organic layer onto a second face of the first glass or glass-ceramic panel;
peeling off any protective film present from a second face of the first organic layer;
applying a second glass or glass-ceramic panel or a second organic layer onto the second face of the first organic layer over an inclined pane or from a glass roll with a closing angle between the second face of the first organic layer and the second glass or glass-ceramic panel or the second organic layer, the second glass or glass-ceramic panel or the second organic layer having a bend prior to the applying step; and
pressing the second glass or glass-ceramic panel or the second organic layer by a roller immediately after the applying step.

35. The method according to claim 34, further comprising heating the roller to greater than 25° C. before the pressing step.

36. The method according to claim 34, wherein the first organic layer comprises a prefabricated composite consisting of at least three organic layers.

37. The method according to claim 34, further comprising, after the pressing step, heating to a temperature in a range of 120° C. to 160° C. for a time of up to 6 hours so that the first and/or second organic layers melts and/or cross-link and hardened.

38. The method according to claim 37, further comprising, during the heating step, applying a vacuum and/or pressure at 5 to 15 kg/cm².
